(19) United States
(12) Patent Application Publication
(10) Pub. No.: US 2013/0315462 A1
(43) Pub. Date: Nov. 28, 2013

(54) Use of a Two-Dimensional Analytical Signal in Sonography

(71) Applicants: Christian Wachinger, Munich (DE); Nassir Navab, Munich (DE)

(72) Inventors: Christian Wachinger, Munich (DE); Nassir Navab, Munich (DE)

(21) Appl. No.: 13/882,142

(22) PCT Filed: Oct. 25, 2011
(86) PCT No.: PCT/EP2011/005384

§ 371 Date: Jul. 17, 2013

(30) Foreign Application Priority Data
Oct. 26, 2010 (DE) 10 2010 049 669.3

(51) Int. Cl. G06T 7/00

(52) U.S. Cl. CPC G06T 7/0012
USPC 382/131

(57) ABSTRACT

The invention relates to a use of a two-dimensional analytic signal in the field of sonography, whereby a sonography method is provided, comprising receiving of signals of reflected sound pulses from a sound source and processing of the received signals to generate an output signal, wherein the processing comprises calculating a two-dimensional analytic signal. A sonography apparatus and a sonography system based thereon are also provided.

### TECHNICAL FIELD

The present invention relates to the use of a two-dimensional analytic signal in the field of sonography, and in particular to procedures and apparatuses for ultrasound imaging that calculate the two-dimensional analytic signal for signal processing of reflected sound pulses.

### BACKGROUND

The term sonography, also known as echography, ultrasound imaging or simply ultrasound, refers to the use of sound pulses and in particular ultrasound pulses as an imaging or image-generating procedure for the non-invasive examination of the internal composition and the internal structure of objects, i.e. that the object to be examined can be examined from the outside without having to dismantle or dismember it. For this purpose, a transducer generally transmits sound pulses, which are absorbed, diffused and reflected in various ways due to the inhomogeneity of the material or tissue inside the object being examined. An echo of the sound pulses reflected back to a receiver, which can be integrated into the transducer itself, is received by it and then processed into a signal that enables conclusions to be drawn about the internal structure of the examined object.

Because of the possibility of non-invasive examination that it offers, sonography is used in numerous fields. For example, in human and in veterinary medicine, the structure, position and arrangement of internal organs or other tissue in a patient or animal can be examined using sonography, without surgical intervention or other invasive measures being required. Furthermore, because of the characteristics of the sound pulses used, sonographic examination does not expose the object or in particular tissue being examined to any harmful radiation. Beyond the applications in human and veterinary medicine, sonography is also used in numerous technical applications, e.g. to investigate technical structures and their material characteristics in the fields of production or quality assurance, or in the field of security, for example, to check visitors, passengers or luggage, and in other areas as well.

One of the advantages of sonography lies in the fact that examinations can be conducted with apparatuses and systems of a relatively simple structure. Simple sonography apparatuses can be as small as a portable minicomputer, e.g. a Personal Digital Assistant, which comprises both the transducer and the receiver, or they are arranged as total systems on a mobile stand that holds both the measurement apparatus and processing units for processing the received signals.

Also beneficial is the fact that sonography does not necessitate any special kind of positioning of the object being examined, the patient or the technical structure, nor does it require data from various spatial directions to generate image data, as is the case with conventional tomography procedures, for example.

Hence, sonography is a technique that is easy to apply, and which allows the non-invasive examination of the internal structures of objects, with highly manageable resources, while delivering rapid results.

One disadvantage of sonography, however, is that the resulting output signals, for example image data, are calculated on the basis of scattered and in some cases multiply reflected sound pulses, which means that they can contain considerable artifacts and disturbing signal noise. Efforts made to date to optimize the resulting output signals have included customary signal processing procedures for the spatial smoothing or averaging of the signals over a specific period of time, or the filtering of certain frequencies. These approaches do provide a better quality of image, but they also often lead to a reduced spatial and structural precision of the output signals and the resolution is usually worse.

### SUMMARY

One object of the invention is to further enhance sonography processing in a way that leads to an improved quality of the output signals.

The problem is solved by the sonography method with features in accordance with claim 1 and by the sonography apparatus with features in accordance with claim 11. The preferred embodiments of the invention are defined in the subclaims.

The sonography method according to the invention includes receiving signals of reflected sound pulses from a sound source, and processing the received signals to generate an output signal, wherein the processing includes calculating a two-dimensional analytic signal. The method according to the invention is hence based on a reflection or scattering of sound pulses on the inside of an object being examined, which are generated and emitted by a sound source. In the method, differences in the (possibly multiple) reflection or scattering arise through inhomogeneities due to differing material or tissue properties inside the object. The signals of a sound pulse reflected (back) in the direction of a receiver are received by it and further processed to an output signal, for example a one, two, three or multi-dimensional, continuous or discrete output signal, the amplitudes of which are intensity values that represent image data or which can be interpreted as image data.

According to the invention, a two-dimensional analytic signal is calculated to process the received signals. The analytic signal is capable of splitting a delivered signal in such a way that quantitative and qualitative information is separately available in two components or quantities, in particular as local phase data and local amplitude data. These quantities of the analytic signal are also invariant and equivariant and enable structural information to be extracted irrespective of brightness, intensity, amplitude or change in contrast in the underlying signal. This means that the analytic signal can be used beneficially in numerous signal processing applications, for example in medical imaging, among others for the registration and segmentation of objects.

The two-dimensional analytic signal is based on a higher order two-dimensional Hilbert transform, the first-order Fourier factors of which, also known as Riesz transform, are defined as follows in the frequency domain:

$${H}_{x}^{1} ( u ) = i \cdot \frac{x}{‖ u ‖}$$

$$and$$

$${H}_{y}^{1} ( u ) = i \cdot \frac{y}{‖ u ‖}$$

whereby u=(x,y) ∈ C\{(0,0)} and i=\sqrt{−1}. The Fourier factors of the second-order Hilbert transform are defined as follows:

$${H}_{xx}^{2} ( u ) = - \frac{x \cdot x}{{‖ u ‖}^{2}} , \\ {H}_{xy}^{2} ( u ) = - \frac{x \cdot y}{{‖ u ‖}^{2}}$$

$$and$$

$${H}_{yy}^{2} ( u ) = - \frac{y \cdot y}{{‖ u ‖}^{2}} .$$

The calculation of the two-dimensional analytic signal of a two-dimensional source signal f ∈ L²(R²) in the spatial domain includes transforming the source signal into a signal representation F in the frequency domain, a filtering of the signal F in the frequency domain with a filter B and a subsequent transformation of the filtered signal with the Fourier factors of the Hilbert transform. For the purpose of simplification, here and in the entire following description, filters and signals in the frequency domain will be denoted using capital letters and their spatial equivalents in the spatial domain will be denoted with the corresponding lower-case letters.

Thus the calculation of the two-dimensional analytic signal includes calculating a filtered signal Fₚ from signal F with a filter B, of signals Fₓ and F_{y} with the first-order Hilbert transform H¹ and of signals Fₓₓ, F_{xy} and F_{yy} with the second-order Hilbert transform H² as follows:

$$[ \begin{matrix}{F}_{p} \\ {F}_{x} \\ {F}_{y}\end{matrix} ] = [ \begin{matrix}B ⊗ F \\ {H}_{x}^{1} ⊗ B ⊗ F \\ {H}_{y}^{1} ⊗ B ⊗ F\end{matrix} ]$$

$$and \\ [ \begin{matrix}{F}_{xx} \\ {F}_{xy} \\ {F}_{yy}\end{matrix} ] = [ \begin{matrix}{H}_{xx}^{2} ⊗ B ⊗ F \\ {H}_{xy}^{2} ⊗ B ⊗ F \\ {H}_{yy}^{2} ⊗ B ⊗ F\end{matrix} ] ,$$

whereby [symbol] is the pointwise multiplication in the frequency domain and filter B is preferably a band-pass filter. The quantitative, qualitative and other derived information can be extracted from the calculated two-dimensional analytic signal.

Because of the characteristics of the two-dimensional analytic signal, in particular strong intensity fluctuations in the received signals and thus variations in the brightness of the output signal can be equalized particularly beneficially, disturbing artifacts can be eliminated and structural features can be highlighted in the output signal. The calculation of structural features of the two-dimensional analytic signal during the initial processing of the received signals leads in particular to a more precise and more consistent output signal. Furthermore, the calculation and use of the two-dimensional analytic signal in the subsequent generation of the output signal leads to a clearer demarcation of local structures. By using and calculating the two-dimensional analytic signal in separate processing steps or in several processing steps, the quality of the resulting image data can hence be considerably improved without reducing the precision and resolution of the output signal.

According to a preferred embodiment, the processing of the received signals includes demodulating the received signals and the demodulating includes calculating an envelope based on the two-dimensional analytic signal. In doing so, an information-bearing signal is extracted from the received signals, which are a modulated carrier signal or a modulated carrier wave. The demodulating of the received signals can include a decomposition, a processing and a compounding of frequency domains of the received signal to an intermediate signal, on the basis of which the envelope is calculated. To accomplish this, the two-dimensional analytic signal can be directly calculated using the received signal or a pre-processed signal that is generated from the received signal. The calculation of the envelope is performed using quantitative information derived from the two-dimensional analytic signal.

According to another preferred embodiment, the calculating of the two-dimensional analytic signal includes calculating a local amplitude of the received signals. The local amplitude represents quantitative information of the two-dimensional analytic signal and reflected structural features of the signal it is based on. For the calculation of the local amplitude, the individual Hilbert transformed signal components of the two-dimensional analytic signal in the frequency domain Fₚ, Fₓ, F_{y}, Fₓₓ, F_{xy} and F_{yy} are transformed back into the spatial domain, wherein the corresponding signal components in the spatial domain are referred to as fₚ, fₓ, f_{y}, fₓₓ, f_{xy} and f_{yy}, in order to calculate

$$\begin{matrix}{f}_{s} = \frac{1}{2} [ {f}_{xx} + {f}_{yy} ] , \\ {f}_{+} = {f}_{xy}\end{matrix}$$

$$and$$

$${f}_{+ -} = \frac{1}{2} [ {f}_{xx} - {f}_{yy} ] .$$

Based on these values, an apex angle α can be calculated as

$$α = arc cos \frac{\sqrt{{f}_{+}^{2} + {f}_{+ -}^{2}}}{‖ {f}_{s} ‖} .$$

The result of this is the homogeneous signal component fₕ of the signal fₚ in the projective space as

$${f}_{h} \sqrt{\frac{1 + cos α}{2}} ,$$

from which the local amplitude a can be directly calculated as

$$a = \frac{1}{2} \sqrt{{f}_{p}^{2} + {[ {f}_{h}^{- 1} {f}_{x} ]}^{2} + {[ {f}_{h}^{- 1} {f}_{y} ]}^{2}} .$$

According to this embodiment, the envelopes are calculated using the local amplitude data, and this leads to much improved envelope detection.

In a particularly preferred embodiment, the received signals include a plurality of scan lines and the two-dimensional analytic signal is calculated simultaneously on the plurality of scan lines. To achieve this, the scan lines are arranged laterally on top of one another and the two-dimensional analytic signal is then calculated on the basis of this arrangement of the lines and columns. Due to the simultaneous calculation of the two-dimensional analytic signal, the envelope recognition can be improved by including additional information from the lateral direction into the analysis.

In another preferred embodiment, the calculating of the two-dimensional analytic signal includes applying one or more band-pass filters. Here, the one or more band-pass filters can define the filter B to calculate the signal components of the two-dimensional analytic signal. The band-pass filters can be Poisson filters, which generate a linear scaling space. The preferred filters for the band-pass filters are, however, log-Gabor filters, the frequency response of which is defined as

G(ω)=e^{-(log(ω/ω}^{₀}⁾^{²}^{/(2·log(k/ω}^{₀}⁾^{²}⁾⁾,

whereby ω₀ is defined as the central frequency and k/ω₀ is defined as the bandwidth of the filter.

In yet another preferred embodiment, the one or more band-pass filters are arranged in a filter bank in such a way that a continuous area of a frequency spectrum is covered uniformly and the two-dimensional analytic signal is calculated on the basis of a response of one band-pass filter or of an accumulation of responses of the band-pass filters. Preferably, the individual filters are arranged in such a way that the frequency response from adjacent filters overlaps in such a way that a uniform coverage of the frequency spectrum is achieved. The band-pass filters can either be integrated individually into the filter function B, in order to be able to extract frequency spectra that are of special interest from the source signal, and to use these as the basis for the further processing, or filter function B can be defined as a combination of several or all band-pass filters, in order to be able to consider more complex frequency domains in the further processing, for example, to exclude frequency bands that are particularly susceptible to noise from the further processing.

According to a particularly preferred embodiment, the bandwidth of the one or more band-pass filters is direction dependent. This means that in particular when simultaneously calculating the two-dimensional analytic signal on several scan lines, the balance between the influence of the individual directional components, for example the lateral and the axial directions, can be adjusted and included, if in particular a higher resolution or a smaller distance between data samples in one direction, for example the axial direction, is to be expected, and this could have a disturbing influence on the calculation results.

According to another embodiment, the calculating of the two-dimensional analytic signal includes calculating a local orientation. Here, the processing of the received signals to calculate the output signal can include generating temporary image data, on the basis of which the two-dimensional analytic signal is calculated. To generate the output signal, a local orientation θ is calculated from the calculated two-dimensional analytic signal as

$$θ = \frac{1}{2} arc tan \frac{{f}_{+}}{{f}_{+ -}} .$$

In a preferred embodiment, the sound source is an ultrasound source, the signals are high-frequency signals and the output signal includes B-mode image data. Preferably, the ultrasound source produces a sound in the frequency domain between 16 kHz and 1.6 GHz, particularly preferred in the frequency domain between 3.0 and 3.5 MHz. Here, the output signal is preferably a discrete one, two or three-dimensional signal, the intensity values of which can be transformed into brightness values for the individual spatial elements, so-called pixels or voxels, and these can be displayed on a display device as gray or color values.

According to the invention, the above problem is further solved by a computer-readable medium having commands stored thereon, which, when executed by a computer cause the computer to execute the method according to the invention.

According to the invention, a sonography apparatus is also provided that includes a receiver for receiving signals of reflected sound pulses from a sound source, and a processing unit for processing the received signals to generate an output signal, wherein the processing unit calculates a two-dimensional analytic signal. Here, the receiver and the sound source can be separate units or preferably integrated into one unit or a transducer, in order to simplify the operating of the apparatus. Furthermore, the receiver and the processing unit can be arranged as two separate units that communicate with each other via a data or signal connection or link, or they can be integrated into a single unit. In particular, the sound source, the receiver and the processing unit can be integrated into a portable unit. The processing unit can also be a processor configured to process the received signals, preferably a multi-core processor, whereby the various cores are configured for the parallel execution of individual processing steps, for example the calculation of the two-dimensional analytic signal. Overall, the sonography apparatus according to the invention provides an output signal of a significantly higher quality and with consistent precision and resolution because of the analysis of the reflected signals using the two-dimensional analytic signal.

In a preferred embodiment, the processing unit includes a demodulator for demodulating the received signals, wherein the demodulator calculates an envelope based on the two-dimensional analytic signal. The demodulator can be a processor or processor core configured for the demodulation of signals, or it can be realized as a parameter-controlled hardware circuit, which extracts an information-carrying signal from a modulated carrier signal or modulated carrier wave on the basis of the parameters.

In another embodiment, the processing unit calculates a local amplitude of the received signals to calculate the two-dimensional analytic signal.

In another preferred embodiment, the received signals include a plurality of scan lines and the processing unit calculates the two-dimensional analytic signal simultaneously on the plurality of scan lines. Here, the processing unit can include a memory that temporarily stores the scan lines and which the processing unit can access in order to calculate the analytic signal for all scan lines simultaneously. The individual scan lines can be recorded consecutively or simultaneously, by providing more than one receiver and/or more than one sound source.

In another preferred embodiment, the processing unit uses one or more band-pass filters to calculate the two-dimensional analytic signal.

According to yet another embodiment, the one or more band-pass filters are arranged in a filter bank in such a way that a continuous area of a frequency spectrum is covered uniformly and the processing unit calculates the two-dimensional analytic signal on the basis of a response from one band-pass filter or of an accumulation of responses of the band-pass filters. The individual band-pass filters in the filter bank can be preconfigured as a dedicated processing unit, for example as a processor or processor core, in order to filter one or more frequency domains of an input signal. Preferably the band-pass filters are Poisson filters or log-Gabor filters.

In another embodiment of the invention, the bandwidth of the one or more band-pass filters is direction dependent.

According to another embodiment, the processing unit calculates a local orientation to calculate the two-dimensional analytic signal.

In another preferred embodiment, the sound source is an ultrasound source, the signals are high-frequency signals and the output signal represents B-mode image data.

According to the invention, a sonography system is also provided that includes an apparatus according to the invention.

### BRIEF DESCRIPTION OF THE FIGURES

Further features, characteristics and advantages of the invention result from the following description of preferred exemplifying embodiments by means of the drawings. Here:

FIG. 1 shows a representation of two-dimensional Hilbert transforms in the frequency domain;

FIG. 2 shows a filter bank with Log-Gabor filters and an ultrasound signal spectrum;

FIG. 3 shows an ultrasound processing procedure in accordance with an embodiment of the present invention;

FIG. 4 shows a comparison of results of an envelope detection according to a customary calculation approach and according to embodiments of the present invention;

FIG. 5 shows the effects of a method according to preferred embodiments of the present invention on generated image data from a sonography in the head/neck area;

FIG. 6 shows a correlation between adjacent scan lines after a calculation of envelopes according to embodiments of the present invention compared with customary approaches;

FIG. 7 shows excerpts of B-mode image data that were generated using customary approaches and according to embodiments of the present invention; and

FIG. 8 shows temporary image data and resulting image data from a biopsy needle, which are processed according to embodiments of the present invention.

### DETAILED DESCRIPTION OF PREFERRED EMBODIMENTS

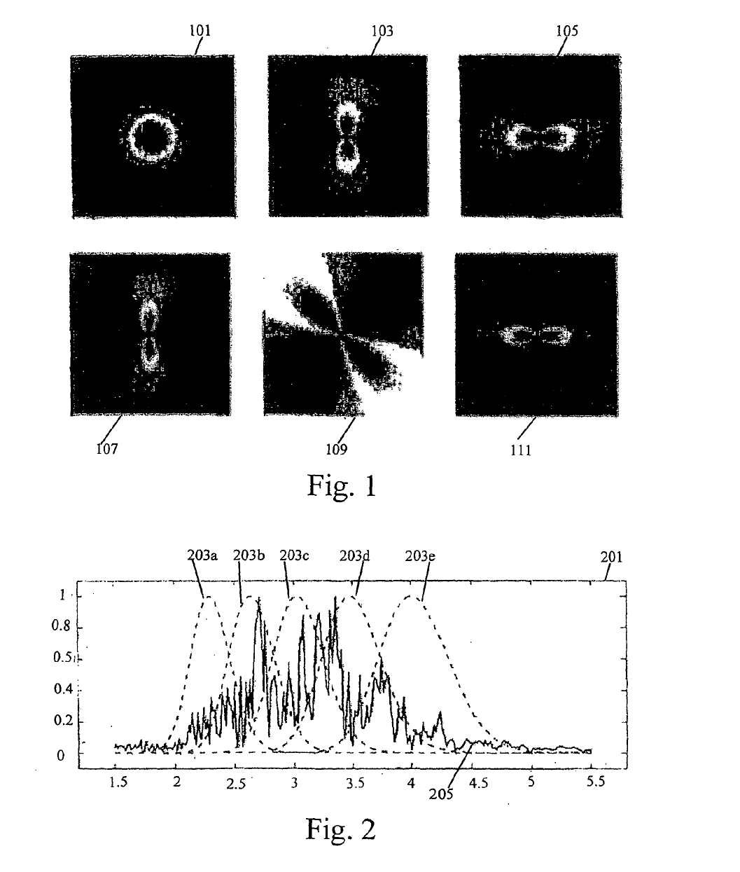

FIG. 1 shows the value of components of a two-dimensional Hilbert transform in the frequency domain linked to a log-Gabor filter. The log-Gabor filter is defined by a filter kernel B with a frequency response 101 in the frequency domain and leads to first-order filtered Hilbert-transformed signals Hₓ¹ [symbol] B and H_{y}¹ [symbol] B, 103 or 105, and to second-order filtered Hilbert-transformed signals Hₓₓ² [symbol] B, H_{xy}² [symbol] B and H_{yy}² [symbol] B, 107, 109 and 111, whereby [symbol] represents the pointwise multiplication in the frequency domain.

According to a preferred embodiment, the two-dimensional analytic signal is obtained through an embedding in a three-dimensional projective space. This enables a differentiation between geometric features (local orientation and local apex angle) and structural features (local phase and local amplitude). In order to make an interpretation of the second-order Hilbert-transformed signal possible in the projective space, an isomorphism between the Hesse matrix and a vector valued representation can be chosen, which leads to

$$\begin{matrix}{f}_{s} = \frac{1}{2} [ {f}_{xx} + {f}_{yy} ] , \\ {f}_{+} = {f}_{xy}\end{matrix}$$

$$and$$

$${f}_{+ -} = \frac{1}{2} [ {f}_{xx} - {f}_{yy} ] .$$

The local features can be calculated from this. The apex angle α, which differentiates between the features of various intrinsic dimensionality, is given as

$$α = arc cos \frac{\sqrt{{f}_{+}^{2} + {f}_{+ -}^{2}}}{‖ {f}_{s} ‖} .$$

With the apex angle α, the homogeneous signal component fₕ of the signal fₚ in the projective space is defined as

$${f}_{h} = \sqrt{\frac{1 + cos α}{2}} ,$$

from which the geometric feature of the local orientation θ results as

$$θ = \frac{1}{2} arc tan \frac{f +}{f + -}$$

and the structural features, i.e. the local phase φ and the local amplitude a, result as

$$φ = a tan 2 ( \sqrt{{[ {f}_{h}^{- 1} {f}_{x} ]}^{2} + {[ {f}_{h}^{- 1} {f}_{y} ]}^{2}} , {f}_{p} )$$

$$and$$

$$a = \frac{1}{2} \sqrt{{f}_{p}^{2} + {[ {f}_{h}^{- 1} {f}_{x} ]}^{2} + {[ {f}_{h}^{- 1} {f}_{y} ]}^{2}} .$$

FIG. 2 shows a filter bank 201 with five log-Gabor filters 203a to 203e, represented as dotted lines, and an ultrasound signal spectrum 205, wherein the x-axis shows the frequency in MHz. The ultrasound signal spectrum 205 illustrated as a solid line was recorded with an ultrasound recording frequency of 3.3 MHz.

In general, any signal f that is defined in a finite interval, i.e. has a finite support, can be represented after periodic continuation by a Fourier series, which decomposes the signal into components of varying frequencies, each of which has its own phase and amplitude. A direct application of the Hilbert transform on the source signal, which represents an accumulation of local signals with varying frequencies, would therefore only insufficiently extract the local features. Theoretically, the analytic signal would have to be calculated for infinitesimally small ranges in the frequency domain, so-called Dirac deltas. Because of the uncertainty principle, however, this would lead to filters with an infinite support in the spatial domain.

In order to prevent this, band-pass filters can be used for the purpose of localization in both the spatial domain and the frequency domain. For example, differences of Poisson filter kernels can be used to select frequencies, whereby a linear scale space is created. Further, log-Gabor filters can preferably be used in sonography to achieve improved results. Since log-Gabor filters cannot be described by a closed analytical expression in the spatial domain, the filters are preferably used in the frequency domain, wherein the frequency response is defined as

G(ω)=e^{-(log(ω/ω}^{₀}⁾^{²}^{/(2·log(k/ω}^{₀}⁾^{²}⁾⁾

with a central frequency ω₀ and a bandwidth k/ω₀.

A key aspect of the design of filters lies in arranging the filters in a filter bank 201 in such a way that adjacent filters overlap sufficiently to achieve a uniform coverage of the frequency spectrum. An exemplary arrangement of filters in a filter bank as shown in FIG. 2 includes five log-Gabor filters 203a to 203e with a bandwidth of k/ω₀=0.93. For example, the central frequencies can be 2.285 MHz, 2.629 MHz, 3.0 MHz, 3.47 MHz and 4.0 MHz.

Based on filters arranged in a filter bank, the further processing can be based on the signal of a certain scale, i.e. the response of a filter or band-pass filter, or the responses from several different scales or all scales can be considered in the further processing. This means that the filters or band-pass filters can be specifically adjusted in order to eliminate disturbing artifacts and disturbing frequencies in the frequency domain.

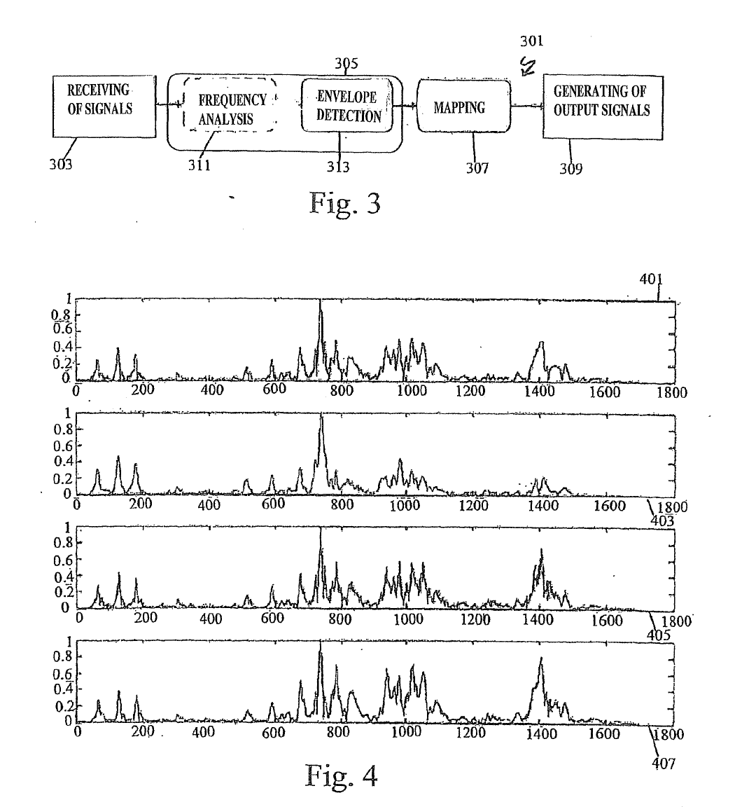

FIG. 3 shows an ultrasound processing process or pipeline 301 according to an embodiment of the present invention that includes receiving 303 reflected signals, demodulating 305 the received signals and mapping 307 an intermediate signal to generate 309 an output signal, wherein the demodulating 305 also comprises a frequency analysis 311 of the received signal and an envelope detection 313 based on it. Here, in a first step, signals of reflected sound pulses, preferably high-frequency signals, are received 303 and subsequently analyzed 311. The analysis can include a selection and compounding of frequencies and delivers a discrete or continuous signal, the envelope of which is calculated in the subsequent step 313. The signal representing the envelope (envelope signal) is then mapped to intensity values, for example by means of a non-linear mapping 307, which are then used to generate 309 an output signal. The output signal can be any one, two, three or multidimensional signal, which can be used to analyze and evaluate the received signals. Preferably, the output signal is a discrete two-dimensional signal with intensity values that can be represented as image data. However, other one or three-dimensional, continuous or discrete output signals can be used for the analysis.

The demodulation 305 extracts the information-bearing signal from a modulated carrier signal or a modulated carrier wave, i.e. from the received signals. According to the embodiment shown in FIG. 3, the detection 313 of the envelope is based on a calculation of a local amplitude of a two-dimensional analytic signal that has been calculated from the received signal.

The received signal may be one or more spatially adjacent scan lines, wherein the analytic signal for the scan lines can be calculated separately. Preferably, the two-dimensional analytic signal can be calculated on all scan lines simultaneously. The calculation of the two-dimensional analytic signal taking into account all scan lines can in particular significantly improve the envelope detection, as the signal is analyzed in its two-dimensional context, in which in addition to axial information also lateral information, i.e. the signal information that belongs to adjacent, laterally arranged scan lines, is included. Preferably, a balance between the influence of signal data both in the lateral and axial directions can be achieved with a corresponding design of the band-pass filters, in which the bandwidths of the band-pass filters are defined direction dependently, wherein in particular the distance between the scan lines or the axial signal resolution can be taken into account.

The envelope signal calculated in this way is then mapped 307 and used to generate 309 the output signal. The selected mapping can be any mapping that maps the envelope signal to intensities. In particular, linear or preferably non-linear transfer functions, for example varying spreading functions, root-based functions, monotone transformations or characteristics-curve-based transformations can be used. To generate 309 the output signal, varying image-processing operations can also be used, for example histogram-based adjustment and equalization of the intensities, various thresholding methods and of local operators to smooth, reduce noise or highlight local features. Brightness-modulated B-mode image data that represent an echo intensity of the received signal that is transformed into brightness values, and hence can be interpreted as a cross-section through the object being examined are preferably used as the resulting image data. The invention is, however, not limited to the generation of B-mode images and can also be used beneficially in one or multi-dimensional ultrasound methods, such as A-mode methods, 3D-ultrasound or 4D-ultrasound.

FIG. 4 shows results of the envelope detection for a central scan line of a high-frequency signal, which was calculated according to embodiments of the present invention, wherein the high-frequency signal was generated with a linear transducer at 3.3 MHz in the head/neck region. Here, envelopes 401 and 403 were determined on the basis of a calculation of a one-dimensional analytic signal, which, in the case of envelope 403 is also filtered with the log-Gabor filters shown in FIG. 2. Furthermore, envelopes 405 and 407 show results of the envelope detection based on a use of a two-dimensional analytic signal, wherein here too, envelope 407 was calculated using the filter bank from FIG. 2. The results from FIG. 4 and in particular from the comparison of envelope 401 with envelope 403 and the comparison of envelope 405 with envelope 407 show that the use of a filter bank leads to smoother envelopes.

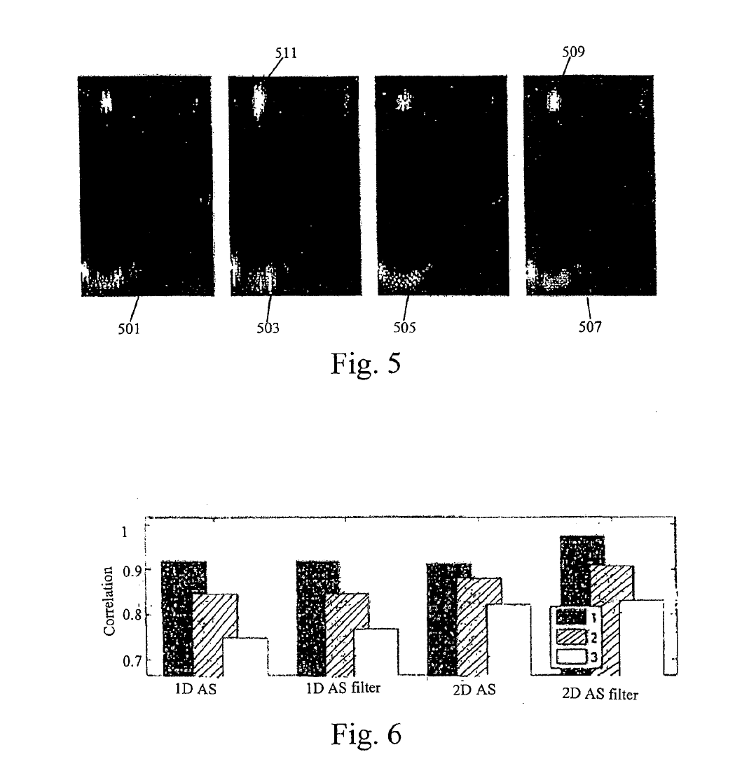

FIG. 5 shows further results of the method according to embodiments of the present invention, wherein the two-dimensional image data generated are shown. Here, images 501 and 503 were calculated on the basis of a one-dimensional analytic signal, and images 505 and 507 using a two-dimensional analytic signal. Furthermore, in images 503 and 507, the analytic signals on which the calculation is based were filtered using the filters in FIG. 2. Also the results shown in FIG. 5 show the positive effect of the filter bank on the resulting image data, in conformity with the results from FIG. 4. Furthermore, the comparison of the filtered images with the unfiltered images, i.e. image 503 with image 501 and image 507 with image 505, shows that there are fewer artifacts and more consistent structures in the filtered images 503 and 507. It can also be seen that the use of the two-dimensional analytic signal delivers a more precise and consistent representation of structures in images 505 and 507. This can be seen in particular in a circular structure 509 in the top left-hand corner of image 507, which only appears as an elliptical structure 511 in the corresponding image 503, which was calculated with a one-dimensional analytic signal.

FIG. 6 shows a correlation comparison for different envelope detection techniques for quantifying the differences of the correlation between scan lines when using a filtered or unfiltered, one-dimensional or two-dimensional analytic signal according to embodiments of the present invention. For this purpose averaged correlation coefficients are each shown as black, hatched and white bars that were calculated between the scan lines with a distance of 1 (i.e. for adjacent scan lines), 2 and 3, respectively, whereby the correlation coefficients are averaged over 256 scan lines of an image. The results from FIG. 6, on the other hand, show the visually improved consistency of images calculated using a filtered two-dimensional analytic signal.

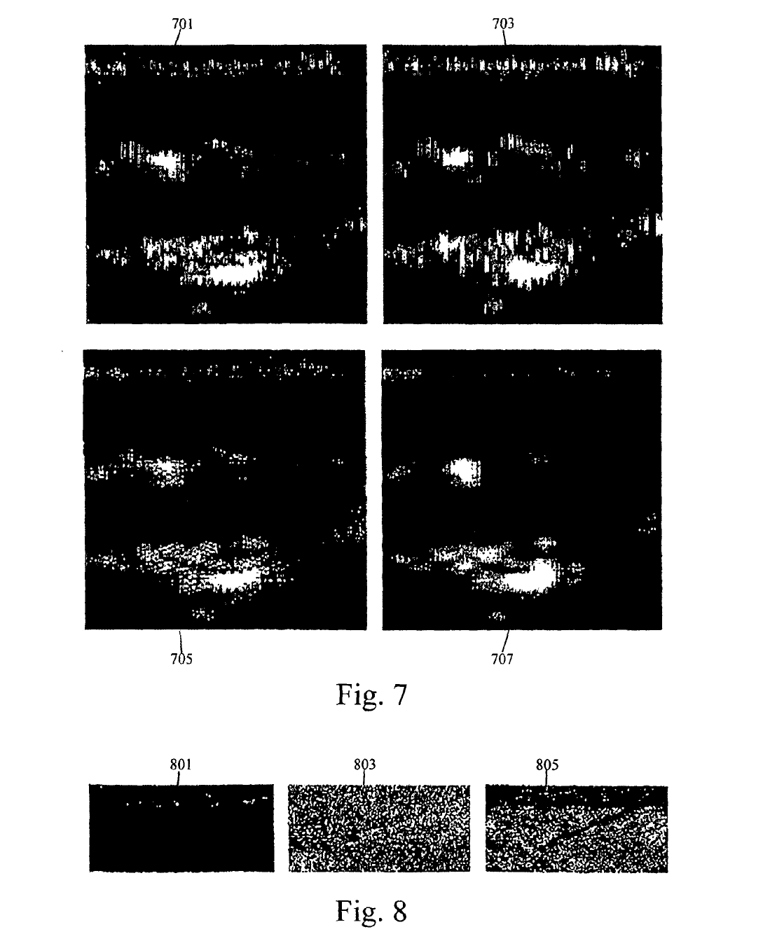

FIG. 7 shows results of a simplified high-frequency signal-to-brightness signal conversion of amplitude images a with a logarithmic compression log(a+25), wherein sections of the image data calculated according to various methods are illustrated as images 701, 703, 705 and 707. The logarithmic compression ultimately leads to a compression of the values, whereby information can also be lost through a discretization of the values, for example to a discrete value range from 1 to 256 or to 2¹⁶ numerical values or to another discrete value range. The images 701 and 703 and the images 705 and 707 were each calculated using a one-dimensional analytic signal or a two-dimensional analytic signal. In addition, on images 703 and 707 the filtering was done with filters according to FIG. 2. Also the results from FIG. 7 show the beneficial use of the filters to demodulate the received signals. Further, image 707, which was calculated with a filtered two-dimensional analytic signal according to an embodiment of the present invention, shows much clearer structures and reduced noise. It is clear to the skilled person that the B-mode image data shown in FIG. 7 differ from those that can be seen in customary ultrasound systems, as in general further image processing steps are applied to enhance the final result. It is, however, also clear that the visible improvements in the images shown also have the same direct effect on possible final image data when comparable image processing operations for post-processing are used, and hence also lead to an improvement in these final image data.

FIG. 8 shows the results of a calculation of B-mode images according to embodiments of the present invention. Here, image 801 shows an intermediate signal mapped with an intensity mapping, which corresponds to a result of step 307 from FIG. 3, and in which the contours of a biopsy needle can be unclearly recognized. This means that in particular the intermediate signal can be already a B-mode image. According to an embodiment of the present invention, a further improvement of the output signal can be achieved by means of an additional or alternative calculation of an analytic signal on the intermediate signal shown in image 801. To do so, the local orientation of the analytic signal of the intermediate signal is calculated. Image 803 shows the result of the calculation, which is based on a one-dimensional analytic signal, and image 805 shows the result of the calculation, which is based on a two-dimensional analytic signal. While image 803 only allows indistinct conclusions to be drawn with regard to the biopsy needle shown, clear structure information is visible in image 805, which enables the biopsy needle to be recognized.

The calculation of the two-dimensional analytic signal from an intensity-mapped intermediate signal hence enables more precise recognition of local features. In this way, in particular the quality of the results of subsequent image processing steps and applications, such as registration, segmentation and feature recognition, which use local features as inputs, can be significantly improved.

To the skilled person it is clear that the calculation of the two-dimensional analytic signal can be calculated according to the invention to demodulate the received signals of the reflected sound pulses or on intermediate signals, and that both can be combined. Thus, as a result, a first two-dimensional analytic signal on the received signals of reflected sound pulses and a second two-dimensional analytic signal on an intermediate signal can be calculated to generate an output signal. Preferably, in a combined calculation of two analytic signals the local amplitude is calculated for envelope detection from the first two-dimensional analytic signal, and the local orientation for the extraction of local features in the output signal is calculated from the second two-dimensional analytic signal. The invention is hence not restricted to calculating a two-dimensional analytic signal on certain intermediate signals, but rather it can include the calculation of multiple two-dimensional analytic signals on multiple intermediate signals.

The use and calculation of a two-dimensional analytic signal both on received signals, such as high-frequency signals, and on intermediate signals, which can represent B-mode images, has numerous advantages. The demodulation of the received signals with the two-dimensional analytic signal enables a more precise extraction of structures, as the signal is analyzed in its natural two-dimensional context. In particular, envelope detection based on the local amplitude of the two-dimensional analytic signal enables the generation of B-mode images with improved quality. Furthermore, the beneficial signal model of the two-dimensional analytic signal leads to a more precise recognition of local features in B-mode images.

The examples and results shown in FIGS. 4 to 8 are based on the scanning of the signals from linear transducers. It is clear to the skilled person that when using curvilinear transducers, the use of the two-dimensional Hilbert transform without a prior scanning conversion can be achieved by means of the polar Fourier transform.

Although the invention has been described with regard to sonography processing, the invention is not limited to a special sonography or ultrasound method or apparatus. Indeed, any application can be considered in which signals of reflected sound pulses from a sound source are received, which have been reflected in an object being examined from structures with varying material or tissue properties or as a result of inhomogeneities of the material or tissue. It is also clear that linear and non-linear sound sources and receivers are also covered in the same way by the invention, as do sound pulses of varying frequency signals.

The characteristics of the invention described in the claims can be important for the realization of the invention either alone or in any desired combination.

1. A sonography method, including the following steps:
receiving signals of reflected sound pulses from a sound source; and
processing the received signals to generate an output signal, wherein the processing includes calculating a two-dimensional analytic signal.

2. The method according to claim 1, wherein the processing of the received signals includes demodulating the received signals and the demodulating includes calculating an envelope based on the two-dimensional analytic signal.

3. The method according to claim 1, wherein the calculating of the two-dimensional analytic signal includes calculating a local amplitude of the received signals.

4. The method according to claim 1, wherein the received signals include a plurality of scan lines and the two-dimensional analytic signal is calculated simultaneously on the plurality of scan lines.

5. The method according to claim 1, wherein the calculating of the two-dimensional analytic signal includes using one or more band-pass filters.

6. The method according to claim 5, wherein the one or more band-pass filters are arranged in a filter bank in such a way that a continuous area of a frequency spectrum is uniformly covered and the two-dimensional analytic signal is calculated on the basis of a response of one band-pass filter or on the basis of an accumulation of responses of the band-pass filters.

7. The method according to claim 5, wherein the frequency range of the one or more band-pass filters is direction dependent.

8. The method according to claim 1, wherein the calculating of the two-dimensional analytic signal includes calculating a local orientation.

9. The method according to claim 1, wherein the sound source is an ultrasound source, the signals are high-frequency signals, and the output signal represents B-mode image data.

10. (canceled)

11. A sonography apparatus, including:
a receiver for receiving signals of reflected sound pulses from a sound source; and
a processing unit for processing the received signals to generate an output signal, wherein the processing unit is configured to calculate a two-dimensional analytic signal.

12. The apparatus according to claim 11, wherein the processing unit includes a demodulator for demodulating the received signals, and wherein the demodulator is configured to calculate an envelope based on the two-dimensional analytic signal.

13. The apparatus according to claim 11, wherein the processing unit is further configured to calculate a local amplitude of the received signals to calculate the two-dimensional analytic signal.

14. The apparatus according to claim 11, wherein the received signals include a plurality of scan lines and the processing unit is further configured to simultaneously calculate the two-dimensional analytic signal on the plurality of scan lines.

15. The apparatus according to claim 11, wherein the processing unit is further configured to use one or more band-pass filters to calculate the two-dimensional analytic signal.

16. The apparatus according to claim 15, wherein the one or more band-pass filters are arranged in a filter bank in such a way that a continuous area of a frequency spectrum is uniformly covered and the processing unit is further configured to calculate the two-dimensional analytic signal on the basis of a response of one band-pass filter or on the basis of an accumulation of responses of the band-pass filters.

17. The apparatus according to claim 15, wherein the frequency range of the one or more band-pass filters is direction dependent.

18. The apparatus according to claim 11, wherein the processing unit is further configured to calculate a local orientation to calculate the two-dimensional analytic signal.

19. The apparatus according to claim 11, wherein the sound source is an ultrasound source, the signals are high-frequency signals, and the output signal represents B-mode image data.

20. A sonography system, including an apparatus comprising:
a receiver for receiving signals of reflected sound pulses from a sound source; and
a processing unit for processing the received signals to generate an output signal, wherein the processing unit is configured to calculate a two-dimensional analytic signal.
